(19) United States
(12) Patent Application Publication
(10) Pub. No.: US 2015/0002446 A1
(43) Pub. Date: Jan. 1, 2015

(54) WIRELESS COMMUNICATION ENABLING CAPACITIVE IMAGING SENSOR ASSEMBLY

(71) Applicant: Synaptics Incorporated, San Jose, CA (US)

(72) Inventor: Oscar AYZENBERG, San Jose, CA (US)

(21) Appl. No.: 13/930,695

(22) Filed: Jun. 28, 2013

(51) Int. Cl. G06F 3/044

(52) U.S. Cl. CPC G06F 3/044
USPC 345/174

(57) ABSTRACT

Embodiments of the invention generally provide a touch sensing device that is integrated with one or more components that are configured to use a wireless communication technique, such as a near field communication (NFC) technique, to communicate with another wireless communication enabled device. Some embodiments of the invention include configurations in which the touch sensing components and one or more NFC enabling components are configured so that the close proximate positioning of these components will minimally affect each other's performance during normal operation. Embodiments of the invention may also provide an integrated touch sensing electrode design and wireless communication coil design that has a reduced system complexity, small overall physical size, low production cost and reduced electrical interaction.

### BACKGROUND OF THE INVENTION

1. Field of the Invention

Embodiments of the present invention generally relate to a method and system that is configured to sense an input object's position and separately communicate with other wireless communication enabled devices.

2. Description of the Related Art

Input devices including proximity sensor devices, also commonly called touchpads or touch sensor devices, are widely used in a variety of electronic systems. A proximity sensor device typically includes a sensing region in which the proximity sensor device determines the presence, location and/or motion of one or more input objects. Proximity sensor devices may be used to provide an interface for the electronic system. For example, proximity sensor devices are often used as input devices for larger computing systems, such as opaque touchpads integrated in, or peripheral to, notebook or desktop computers. Proximity sensor devices are also often used in smaller computing systems, such as touch screens integrated in cellular phones.

Proximity sensor devices are typically used in combination with other supporting components, such as display or input devices found in the electronic or computing system. In some configurations, the proximity sensor devices are coupled to these supporting components to provide a desired combined function or to provide a desirable complete device package. Many commercially available proximity sensor devices utilize one or more electrical techniques to determine the presence, location and/or motion of an input object, such as a capacitive or a resistive sensing technique. Typically, the proximity sensor devices utilize a plurality of sensor electrodes to detect the presence, location and/or motion of an input object. The sensor electrodes are typically formed on one or more layers of the proximity sensor device that is adjacent to a sensing region of the proximity sensor device. The sensor electrodes typically include a layer of a conductive material, such as copper (Cu) and/or transparent conductive oxide (TCO) material, that is segmented into shaped elements and is disposed adjacent to a surface of the sensing region of the proximity sensor device. Due to the often large number of sensor electrodes used to sense the presence and position of an input object with desirable accuracy, and also the need to connect each of these sensor electrodes to the various signal generation and data collection components in the electronic or computing system, the cost associated with forming these interconnections, the reliability of the system and the overall size of the proximity sensor device are often undesirably large and complex. It is a common goal in the consumer and industrial electronics industries to reduce the cost and/or size of the electrical components in the formed electronic device.

Moreover, the greater the length of the traces used to interconnect the sensor electrodes to the computer system, the more susceptible the proximity sensor device is to interference, such as electromagnetic interference (EMI), commonly generated by the other supporting components. The interference provided by these supporting components will adversely affect the reliability and accuracy of the data collected by the proximity sensing device. Current commercial electronic or computing systems have commonly resorted to finding ways to reduce the magnitude of the interference by distancing the EMI generating components from the proximity sensing device and/or adding shielding components to the device package, thus making the system more expensive and/or needlessly increasing the size of the complete system package.

Latest generation of proximity sensor devices, or touch pad sensor containing designs, are optimized for best trans-capacitance sensing performance. However, wireless technologies, such as near Field Communication (NFC) have been used in various industries as a way to transfer data between two or more devices. Some typical uses of NFC communication techniques include contactless payment transactions, data exchange and simplified setup of more complex communications, such as Wi-Fi. In some cases, communication is completed between one NFC containing device and an unpowered NFC chip that is mounted in a separate unit, which is often called a “tag”. However, to communicate via an NFC technique, the various communicating devices will each use an antenna that is driven and/or configured to receive a radio frequency signals. Thus, electric currents induced within conductor found in the transmitting antenna induce a magnetic field that radiates from the transmitting antenna to the receiving antenna. For successful Near Field Communication (NFC) it is desirable that there is a minimum magnetic field attenuation between the two antennas. However, when NFC antennas are placed near conventional touch sensing devices the conductive elements in the touch sensing device will typically severely attenuate the magnetic field induced NFC signal. The attenuation of the NFC signal is usually a result of eddy currents that are induced in any metal object that has a significant size and is positioned proximate to the NFC communicating antennas. Positioning of the NFC communicating antennas proximate to the touch sensing device will also increase the electrical capacitance of the antenna and thus create an undesirable reduction in the self-resonance frequency of the antenna which will affect the ability of the tuned NFC components to communicate with each other.

Therefore, there is a need for an apparatus and method of forming a proximity sensing device that is reliable, provides consistent and accurate position sensing results, is inexpensive to produce and can be integrated with a wireless communicating device.

### SUMMARY OF THE INVENTION

Embodiments of the invention generally provide a touch sensing device that is integrated with one or more components that are configured to wirelessly communicate with other wireless communication enabled devices. Embodiments of the invention include configurations in which the touch sensing device components and wireless communication components are configured to minimally affect each other's performance during normal operation.

Embodiments of the invention generally provide an input device, comprising an array of capacitive sensing electrodes comprising a plurality of pairs of sensor electrodes that are separated by a first gap, wherein the first gaps between two or more pairs of sensor electrodes are aligned along a first direction. The input device also includes a coil having a planar loop that is disposed within a first plane, wherein the first plane is parallel to the first direction and a second direction. The planar loop comprising a first conductive trace having a first length that is positioned over the first gaps formed between the two or more pairs of sensor electrodes.

Embodiments of the invention may further provide an input device, comprising an array of capacitive sensing electrodes that include a plurality of sensor electrodes that are arranged in columns and rows relative to a first plane, wherein a first gap is formed between each adjacently positioned sensor electrode in the columns and a second gap is formed between each adjacently positioned sensor electrode in the rows. The input device also includes a coil having at least one planar loop that is disposed in a second plane, wherein the second plane is parallel to the first plane. The at least one planar loop comprising a conductive trace having a first length that is positioned over a plurality of the first gaps and a second length that is positioned over a plurality of the second gaps.

Embodiments of the invention may further provide an input device, comprising an array of capacitive sensing electrodes comprising a plurality of first sensor electrodes and a plurality of second sensor electrodes, wherein each first sensor electrode comprises a body region that has one or more slots formed therein, and are aligned along a first direction. The input device also includes a coil having at least one planar loop that is disposed in a first plane, wherein the first plane is parallel to the first direction and a second direction, and the at least one planar loop comprises a conductive trace that is positioned over each of the first sensor electrodes that are aligned along the first direction.

Embodiments of the invention may further provide a method of forming an input device, comprising receiving a substrate comprising an array of capacitive sensing electrodes that are disposed on a first surface of the substrate, wherein the array of capacitive sensing electrodes comprise a plurality of pairs of sensor electrodes that are separated by a first gap, wherein the first gaps between two or more pairs of sensor electrodes are aligned along a first direction, and bonding a coil having a planar loop to the first surface of the substrate, wherein the bonded planar loop is disposed parallel to the first surface, and bonding the coil further comprises aligning a conductive trace of the planar loop over the first gaps.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic block diagram of an exemplary input device, in accordance with embodiments of the invention.

FIG. 2A is a schematic diagram illustrating a portion of an input device, according to at least one embodiment of the invention.

FIG. 2B is a schematic diagram illustrating an input device, according to at least one embodiment of the invention.

FIG. 3A is a schematic side cross-sectional view of a portion of an input device, according to one embodiment of the invention.

FIG. 3B is a schematic side cross-sectional view of a portion of an input device, according to one embodiment of the invention.

FIG. 4A is a schematic plan view of the sensing region of an input device, according to one embodiment of the invention.

FIG. 4B is an enlarged plan view of a portion of the sensing region shown in FIG. 4A, according to one embodiment of the invention.

FIGS. 4C-4D are enlarged plan views of a plurality of sensor electrodes that are disposed within a portion of the sensing region, according to one or more embodiments of the invention.

FIG. 5A is a schematic plan view of the sensing region of an input device, according to one embodiment of the invention.

FIG. 5B is an enlarged plan view of a portion of the sensing region shown in FIG. 5A, according to one embodiment of the invention.

FIGS. 5C-5F are enlarged plan views of a plurality of sensor electrodes that can be disposed within a portion of the sensing region, according to one or more embodiments of the invention.

FIG. 6 is an enlarged plan view of a plurality of sensor electrodes that can be disposed within a portion of the sensing region, according to one embodiment of the invention.

FIG. 7 is an enlarged plan view of a plurality of sensor electrodes that can be disposed within a portion of the sensing region, according to one embodiment of the invention.

To facilitate understanding, identical reference numerals have been used, where possible, to designate identical elements that are common to the figures. It is contemplated that elements disclosed in one embodiment may be beneficially utilized on other embodiments without specific recitation. The drawings referred to here should not be understood as being drawn to scale unless specifically noted. Also, the drawings are often simplified and details or components omitted for clarity of presentation and explanation. The drawings and discussion serve to explain principles discussed below, where like designations denote like elements.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

Embodiments of the invention generally provide a touch sensing device that is integrated with one or more components that are configured to use a wireless communication technique, such as a near field communication (NFC) technique, to communicate with another wireless communication enabled device. Some embodiments of the invention will include configurations in which the touch sensing components and one or more NFC enabling components are configured so that the close proximate positioning of these components will minimally affect each other's performance during normal operation. Embodiments of the invention may also provide an integrated touch sensing electrode design and wireless communication coil design that has a reduced system complexity, small overall physical size, low production cost and reduced electrical interaction (e.g., EMI affected performance). One or more of the embodiments discussed herein comprise an input device that includes a plurality of touch sensing elements that are interconnected in desired way to reliably and accurately acquire positional information of an input object. The acquired positional information may be used to control the system's operation mode, as well as graphical user interface (GUI) actions, such as cursor movement, selection, menu navigation, and other functions. The input device may further include a coil, such as an NFC antenna, that is configured to facilitate the communication between the touch sensing device and other external devices using a wireless communication technique.

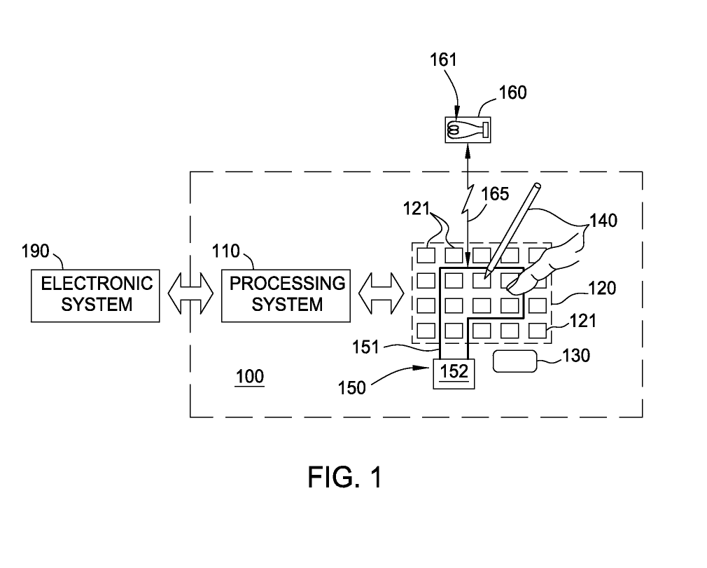

FIG. 1 is a block diagram of an exemplary input device 100, in accordance with embodiments of the invention. In FIG. 1, the input device 100 is a proximity sensor device (e.g., “touchpad,” “touch screen,” “touch sensor device”) configured to sense inputs provided by one or more input objects 140 positioned in a sensing region 120. Example input objects include fingers and styli, as shown in FIG. 1. In some embodiments of the invention, the input device 100 may be configured to provide input to an electronic system 190, which is sometimes referred to herein as the “host.” As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional examples of electronic systems include composite input devices, such as physical keyboards that include input device 100 and separate joysticks or key switches. Further examples of electronic systems 190 include peripherals, such as data input devices (e.g., remote controls and mice) and data output devices (e.g., display screens and printers). Other examples include remote terminals, kiosks, video game machines (e.g., video game consoles, portable gaming devices, and the like), communication devices (e.g., cellular phones, such as smart phones), and media devices (e.g., recorders, editors, and players such as televisions, set-top boxes, music players, digital photo frames, and digital cameras). Additionally, the electronic system could be a host or a slave to the input device.

The input device 100 can be implemented as a physical part of the electronic system 190, or can be physically separate from the electronic system. As appropriate, the input device 100 may communicate with parts of the electronic system 190 using any one or more of the following: buses, networks, and other wired or wireless interconnections. Examples include I²C, SPI, PS/2, Universal Serial Bus (USB), Bluetooth, RF, and IRDA.

Sensing region 120 encompasses any space above, around, in and/or near the input device 100 in which the input device 100 is able to detect user input by one or more input objects 140. The sizes, shapes, and locations of particular sensing regions may vary widely from embodiment to embodiment. In some embodiments, the sensing region 120 extends from a surface of the input device 100 in one or more directions into space until signal-to-noise ratios prevent sufficiently accurate object detection. The distance to which this sensing region 120 extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device 100, contact with an input surface (e.g., a touch surface) of the input device 100, contact with an input surface of the input device 100 coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region 120 has a rectangular shape when projected onto an input surface of the input device 100.

The input device 100 may utilize any combination of sensor components and sensing technologies to detect user input in the sensing region 120. The input device 100 generally comprises one or more sensing elements 121 for detecting user input. As several non-limiting examples, the one or more sensing elements 121 in the input device 100 may use capacitive, elastive, resistive, inductive, magnetic acoustic, ultrasonic, and/or optical techniques to detect the position or motion of the input object(s) 140. Some implementations are configured to provide sensing images that span one, two, three, or higher dimensional spaces.

In some embodiments, the input device 100 may further include a wireless communication system 150 that is configured to communicate with a wireless communication device 160 via a communication link 165. In one configuration, the wireless communication system 150 is configured to use an NFC communication technique (e.g., ISO/IEC 14443 standard) to communicate with the wireless communication device 160, such as a contactless smart card or NFC “tag”. In one embodiment, the wireless communication system 150 includes a signal processing unit 152 and coil 151 that are used in combination to transmit signals to the wireless communication device 160 and/or receive signals from the wireless communication device 160. As is illustrated in FIG. 1 and is discussed further below, due to the need to conserve space, use a coil 151 that is sized to improve communication/coupling between the wireless communication devices and the presence of EMI shielding in the system, it is often desirable to position the coil 151 at or within the sensing region 120.

In FIG. 1, a processing system 110 is shown as part of the input device 100. The processing system 110 is configured to operate the hardware of the input device 100 to detect input in the sensing region 120 and transmit and/or receive the wireless communication signals using the wireless communication system 150. The processing system 110 comprises parts of or all of one or more integrated circuits (ICs) and/or other circuitry components. In some embodiments, the processing system 110 also comprises electronically-readable instructions, such as firmware code, software code, and/or the like. In some embodiments, components composing the processing system 110 are located together, such as all of the components being near the sensing element(s) 121 of the input device 100 and/or the signal processing unit 152 of the wireless communication system 150. In other embodiments, components of processing system 110 are separate from each other. In one example, one component of the processing system 110 is close to the sensing elements 121, and another component is elsewhere. For example, the input device 100 may be a peripheral coupled to a desktop computer, and the processing system 110 may comprise software configured to run on a central processing unit of the desktop computer and one or more ICs (perhaps with associated firmware) separate from the central processing unit. As another example, the input device 100 may be physically integrated in a phone, and the processing system 110 may comprise circuits and firmware that are part of a main processor of the phone. In some embodiments, the processing system 110 is dedicated to implementing the input device 100. In other embodiments, the processing system 110 also performs other functions, such as operating display screens, driving haptic actuators, etc.

The processing system 110 may be implemented as a set of modules that handle different functions of the input device 100. Each module may comprise circuitry that is a part of the processing system 110, firmware, software, or a combination thereof. In various embodiments, different combinations of modules may be used. In one example, modules include hardware operation modules for operating hardware such as sensing elements and display screens, data processing modules for processing data, such as sensor signals, and positional information, and reporting modules for reporting information. In another example, modules include sensor operation modules configured to operate sensing element(s) to detect input, identification modules configured to identify gestures such as mode changing gestures, and mode changing modules for changing operation modes.

In some embodiments, the processing system 110 responds to user input (or lack of user input) in the sensing region 120 directly by causing one or more actions. In one example, as noted above, actions may include changing operation modes, as well as GUI actions, such as cursor movement, selection, menu navigation, and other functions. In some embodiments, the processing system 110 provides information about the input (or lack of input) to some part of the electronic system (e.g., to a central processing system of the electronic system that is separate from the processing system 110, if such a separate central processing system exists). In some embodiments, some part of the electronic system process information received from the processing system 110 is used to act on user input, such as to facilitate a full range of actions, including mode changing actions and GUI actions. For example, in some embodiments, the processing system 110 operates the sensing element(s) 121 of the input device 100 to produce electrical signals indicative of input (or lack of input) in the sensing region 120. The processing system 110 may perform any appropriate amount of processing on the electrical signals in producing the information provided to the electronic system. For example, the processing system 110 may digitize analog electrical signals obtained from the sensing elements 121. As another example, the processing system 110 may perform filtering or other signal conditioning. As yet another example, the processing system 110 may subtract or otherwise account for a baseline set of data (e.g., baseline image), such that the information reflects a difference between the acquired electrical signals (e.g., sensing image) and the baseline. As yet further examples, the processing system 110 may determine positional information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, the input device 100 is implemented with additional input components that are operated by the processing system 110 or by some other processing system. These additional input components may provide redundant functionality for input in the sensing region 120, or some other functionality. FIG. 1 shows a button 130 near the sensing region 120 that can be used to facilitate selection of items using the input device 100. Other types of additional input components include sliders, balls, wheels, switches, and the like. Conversely, in some embodiments, the input device 100 may be implemented with no other input components.

In some embodiments, the input device 100 comprises a touch screen interface, and the sensing region 120 overlaps at least part of an active area of a display screen of a display device (not shown). For example, the input device 100 may comprise substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device 100 and the display device may share physical elements. Some embodiments of the input device 100 include at least part of the display device. For example, some embodiments may utilize some of the same electrical components for displaying and sensing. In some examples, the display screen of the display device may be operated in part or in total by the processing system 110.

It should be understood that while many embodiments of the present technology are described in the context of a fully functioning apparatus, the mechanisms of the present technology are capable of being distributed as a program product (e.g., software) in a variety of forms. For example, the mechanisms of the present technology may be implemented and distributed as a software program on information bearing media that are readable by electronic processors (e.g., non-transitory computer-readable and/or recordable/writable information bearing media readable by the processing system 110). Additionally, the embodiments of the present technology apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

In many embodiments, the positional information of the input object 140 relative to the sensing region 120 is monitored or sensed by use of one or more sensing elements 121 (FIG. 1) that are positioned to detect its “positional information.” In general, the sensing elements 121 may comprise one or more sensing elements or components that are used to detect the presence of an input object. As discussed above, the one or more sensing elements 121 of the input device 100 may use capacitive, elastive, resistive, inductive, magnetic acoustic, ultrasonic, and/or optical techniques to sense the positional information of an input object. While the information presented below primarily discusses the operation of an input device 100, which uses capacitive sensing techniques to monitor or determine the positional information of an input object 140 this configuration is not intended to be limiting as to the scope of the invention described herein, since other sensing techniques may be used.

In one embodiment of the input device 100, the sensing element 121 is a capacitive sensing element that is used to sense the positional information of the input object(s). In some capacitive implementations of the input device 100, voltage or current is applied to the sensing elements to create an electric field between an electrode and ground. Nearby input objects 140 cause changes in the electric field, and produce detectable changes in capacitive coupling that may be detected as changes in voltage, current, or the like. Some capacitive implementations utilize arrays or other regular or irregular patterns of capacitive sensing elements to create electric fields. In some capacitive implementations, portions of separate sensing elements may be ohmically shorted together to form larger sensor electrodes. Some capacitive implementations utilize resistive sheets, which may be uniformly resistive.

Some capacitive implementations utilize “self capacitance” (or “absolute capacitance”) sensing methods based on changes in the capacitive coupling between one or more sensing elements, or one or more sensor electrodes, and an input object. In various embodiments, an at least partially grounded input object positioned near the sensor electrodes alters the electric field near the sensor electrodes, thus changing the measured capacitive coupling of the sensor electrodes to ground. In one implementation, an absolute capacitance sensing method operates by modulating sensor electrodes with respect to a reference voltage (e.g., system ground), and by detecting the capacitive coupling between the sensor electrodes and the at least partially grounded input object(s).

Some capacitive implementations utilize “mutual capacitance” (or “transcapacitance”) sensing methods based on changes in the capacitive coupling between two or more sensing elements (e.g., sensor electrodes). In various embodiments, an input object near the sensor electrodes alters the electric field created between the sensor electrodes, thus changing the measured capacitive coupling. In one implementation, a transcapacitive sensing method operates by detecting the capacitive coupling between one or more transmitter sensor electrodes (also “transmitter electrodes,” “transmitting electrodes,” “transmitters” of “Tx” electrodes) and one or more receiver sensor electrodes (also “receiver electrodes,” “receiving electrodes” or “Rx” electrodes). Transmitter sensor electrodes may be modulated relative to a reference voltage (e.g., system ground) to transmit transmitter signals. Receiver sensor electrodes may be held substantially constant relative to the reference voltage to facilitate receipt of “resulting signals.” A “resulting signal” may comprise effect(s) corresponding to one or more transmitter signals, and/or to one or more sources of environmental interference (e.g., other electromagnetic signals). Sensor electrodes may be dedicated transmitters or receivers, or may be configured to both transmit and receive. In some implementations user input from an actively modulated device (e.g. an active pen) may act as a transmitter such that each of the sensor electrodes act as a receiver to determine the position of the actively modulated device.

Most conventional multi-touch sensing sensor devices, in which the location of more than one finger or other input can be accurately determined, comprise a matrix of transmitter sensor electrodes and receiver sensor electrodes. Conventionally, during operation, capacitive images are formed by measuring the capacitance formed between each transmitter and receiver sensor electrode (referred to as “transcapacitance” or “mutual capacitance”), forming a matrix or grid of capacitive detecting elements across the sensing region 120. The presence of an input object (such as a finger or other object) at or near an intersection between transmitter and receiver sensor electrodes changes the measured “transcapacitance”. These changes are localized to the location of object, where each transcapacitive measurement is a pixel of a “capacitive image” and multiple transcapacitive measurements can be utilized to form a capacitive image of the object.

Herein sensor design and sensing scheme embodiments are described that allow the creation of 2-D capacitance images using transmitting and receiving sensor electrodes that are disposed in one or more layers at or within the sensing region 120. The electronics to drive the sensor are located in a processing system, such as processing system 110 described herein. These described embodiments also facilitate contact sensing, proximity sensing, and position sensing. These described embodiments also facilitate “multi-touch” sensing, such as two finger rotation gestures and two finger pinch gestures, but with a less expensive sensor compared to a sensor that utilizes sensor electrodes in multiple layers. Additional electrodes involved in sensing the shape of the electric fields of the transmitters and receivers, such as floating electrodes or shielding electrodes, may be included in the input device and may be placed on other substrates or layers in at least one substrate. The electrodes may be part of a display (share a substrate) and may even share functionality with the display (used for both display and sensing functionality). For example electrodes may be patterned in the Color filter of an LCD (Liquid Crystal Display) or on the sealing layer of an OLED (Organic Light Emitting Diode) display. Alternately, sensing electrodes within the display or on TFT (Thin Film Transistor) layer of an active matrix display may also be used as gate or source drivers. Such electrodes may be patterned (e.g. spaced or oriented at an angle relative to the pixels) such that they minimize any visual artifacts. Furthermore, they may use hiding layers (e.g. Black Mask between pixels) to hide at least some portion of one or more conductive electrodes.

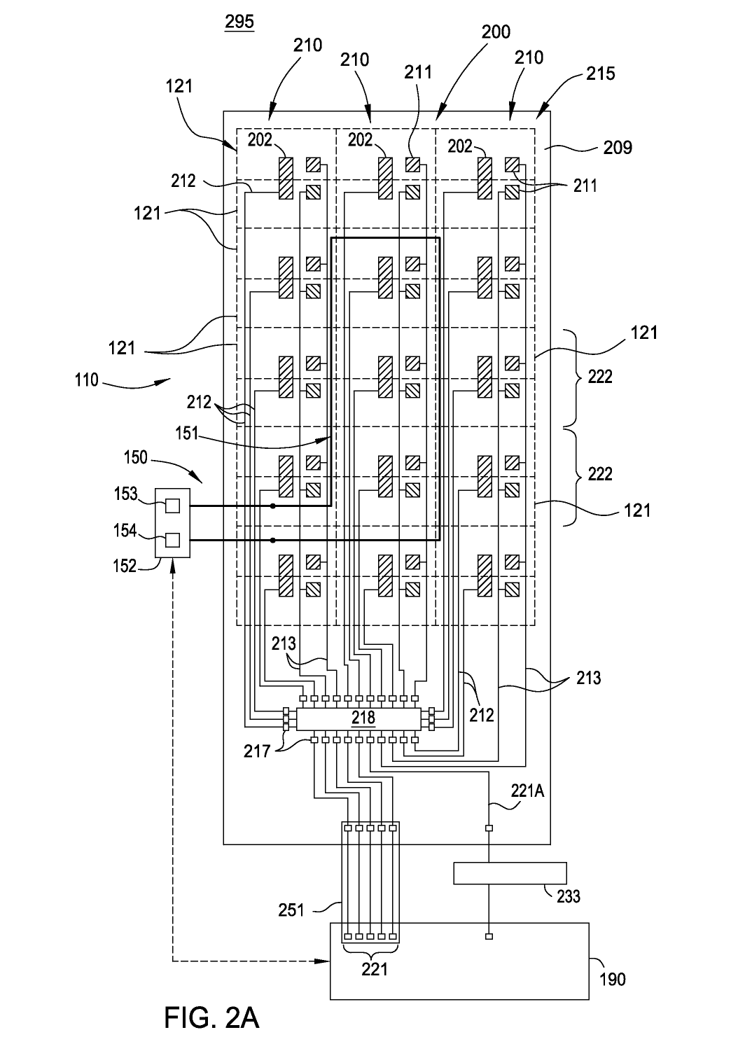

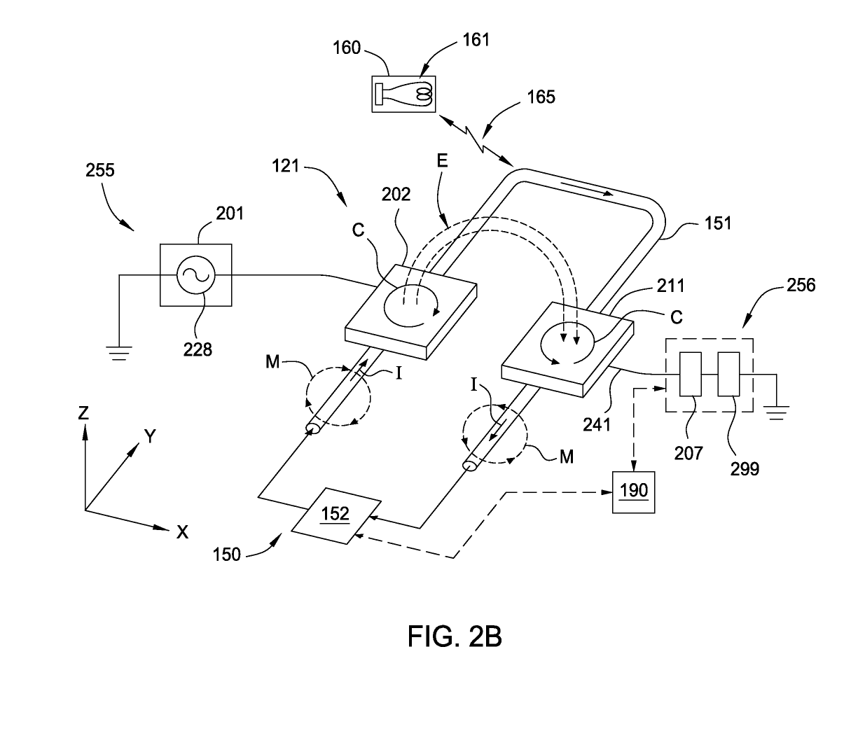

FIG. 2A is a schematic top view of a portion of an input device 295 that illustrates a portion of a sensor electrode pattern that may be used to sense the positional information of an input object within the sensing region 120 using a transcapacitive sensing method. One will note that the input device 295 may be formed as part of a larger input device 100, which is discussed above. In general, the sensor electrode pattern disclosed herein comprises an array of sensing elements 215 that includes a plurality of sensor electrode arrays 210 that include a plurality of sensor electrodes, such as sensor electrodes 202 and 211, that are arranged and interconnected in a desirable manner to reduce or minimize the number of traces 212, 213 and/or sensor electrodes required to sense the positional information of an input object within the sensing region 120 of the input device 295. In one example, a sensor electrode array 210 includes a plurality of sensor electrodes 202 and 211 that are aligned in columns (e.g., three columns shown in FIG. 2A). Sensor electrode arrays 210 may be grouped together to form an array of sensing elements 215, which may have sensor electrodes 202 and 211 that are aligned in a desired configuration, such as being aligned in rows and columns. For clarity of illustration and description, while FIG. 2A illustrates a pattern of simple rectangles used to represent the sensor electrodes (e.g., electrodes 202 and 211), this configuration is not meant to be limiting and in other embodiments, various other sensor electrode shapes may be used as discussed further herein. In some embodiments, sensing elements 121 comprise two or more sensor electrodes, for example, sensor electrodes 202 and 211 that may be similar or different in size and/or shape. In one example, as shown, these sensor electrodes are disposed in a sensor electrode pattern that comprises a first plurality of sensor electrodes 202 (e.g., 15 shown) and a second plurality of sensor electrodes 211 (e.g., 30 shown), which are disposed on the same layer or adjacent layers as the first plurality of sensor electrodes 202. Sensor electrodes 202 and sensor electrodes 211 are typically ohmically isolated from each other, by use of insulating materials or a physical gap formed between the electrodes to prevent them from electrically shorting to each other. In some configurations, two or more sensing elements 121 may form a larger unit cell 222. A unit cell 222 includes a grouping of sensor electrodes that are repeated within a sensor electrode array 210 and/or in a repeating pattern across the sensing region 120 (e.g., multiple sensor electrode arrays 210). The unit cell 222 is the smallest unit a symmetric grouping of sensor electrodes that can be broken into an electrode pattern formed across the sensing region 120. As illustrated in FIG. 2A, in one example, the unit cell 222 includes two sensing elements 121, which each contain a portion of the sensor electrode 202 and the sensor electrode 211, and thus the unit cell 222 comprises a sensor electrode 202 and two sensor electrodes 211. One will note that the sensor electrode pattern of FIG. 2A may alternatively utilize various sensing techniques, such as mutual capacitive sensing, absolute capacitive sensing, elastive, resistive, inductive, magnetic acoustic, ultrasonic, or other useful sensing techniques, without deviating from the scope of the invention described herein. Sensor electrode 202 maybe be a transmitter and sensor electrode 211 maybe a receiver, or vice versa (the other way around) with typically similar imaging capability.

In one embodiment, as illustrated in FIG. 2A, the sensing elements 121 may comprise an array of sensing elements 215 that include a plurality of transmitter and receiver electrodes that are formed on a substrate 209. In one configuration of the input device 295, each of the sensor electrodes may comprise one or more transmitter electrodes (e.g. sensor electrodes 202) that are disposed proximate to one or more receiver electrodes (e.g. sensor electrodes 211). In one example, a transcapacitive sensing method, may operate by detecting the change in capacitive coupling between one or more of the driven transmitter sensor electrodes and one or more of the receiver electrodes, as similarly discussed above. The areas of localized capacitive coupling formed between at least a portion of one or more sensor electrodes 202 and at least a portion of one or more sensor electrodes 211 may be termed a “capacitive pixel,” or also referred to herein as the sensing element 121. For example, the capacitive coupling in a sensing element 121 may be created by the electric field “E” (FIG. 2B) formed between at least a portion of the sensor electrodes 202 and a sensor electrode 211, which changes as the proximity and motion of input objects across the sensing region changes.

In various embodiments, the transmitter electrodes and receiver electrodes may be formed in an array on the surface of a substrate 209 by first forming a blanket conductive layer on the surface of the substrate 209 and then performing an etching and/or patterning process (e.g., lithography and wet etch, laser ablation, etc.) that ohmically isolates each of the transmitter electrodes and receiver electrodes from each other. In other embodiments, the sensor electrodes may be patterned using deposition and screen printing methods and/or may be formed on the same or separate layers within the substrate 209. In one example, the blanket conductive layer used to form the transmitter electrodes and receiver electrodes comprises a thin metal layer (e.g., copper, aluminum, etc.) or a thin transparent conductive oxide layer (e.g., ATO, ITO, Zinc oxide) that is deposited using convention deposition techniques known in the art (e.g., PVD, CVD). In various embodiments, patterned isolated conductive electrodes (e.g., electrically floating electrodes) may be used to improve visual appearance. In one or more of the embodiments described herein, the sensor electrodes are formed from a material that is substantially optically clear, and thus, in some configurations, can be disposed between a display device and the input device user.

In some embodiments, the sensing elements 121 are “scanned” to determine these capacitive couplings. The input device 295 may be operated such that one transmitter electrode transmits at one time, or multiple transmitter electrodes transmit at the same time. Where multiple transmitter electrodes transmit simultaneously, these multiple transmitter electrodes may transmit the same transmitter signal and effectively produce an effectively larger transmitter electrode, or these multiple transmitter electrodes may transmit different transmitter signals. In one example, multiple sensor electrodes 202 transmit different transmitter signals according to one or more coding schemes that enable their combined effects on the resulting signals received by the receiving sensor electrodes, or sensor electrodes 211, to be independently determined. The direct effect of a user input which is coupled to the device may affect (e.g. reduce the fringing coupling) of the resulting signals. The receiver electrodes, or a corresponding sensor electrode 211, may be operated singly or multiply to acquire resulting signals created from the transmitter signal. The resulting signals may be used to determine measurements of the capacitive couplings at the capacitive pixels, which are used to determine whether an input object is present and its positional information, as discussed above. A set of values for the capacitive pixels form a “capacitive image” (also “capacitive frame” or “sensing image”) representative of the capacitive couplings at the pixels. In various embodiments, the sensing image, or capacitive image, comprises data received during a process of measuring the resulting signals received with at least a portion of the sensing elements 121 distributed across the sensing region 120. The resulting signals may be received at one instant in time, or by scanning the rows and/or columns of sensing elements distributed across the sensing region 120 in a raster scanning pattern (e.g., serially polling each sensing element separately in a desired scanning pattern), row-by-row scanning pattern, column-by-column scanning pattern or other useful scanning technique. In many embodiments, the rate that the “sensing image” is acquired by the input device 100, or sensing frame rate, is between about 60 and about 180 Hertz (Hz), but can be higher or lower depending on the desired application.

In some touch screen embodiments, the sensing elements 121 are disposed on a substrate of an associated display device. For example, the sensor electrodes 202 and/or the sensor electrodes 211 may be disposed on a polarizer, a color filter substrate, or a glass sheet of an LCD. As a specific example, the sensor electrodes 202 and 211 may be disposed on a TFT (Thin Film Transistor) substrate of an LCD type of the display device, a color filter substrate, on a protection material disposed over the LCD glass sheet, on a lens glass (or window), and the like. The electrodes may be separate from and in addition to the display electrodes, or shared in functionality with the display electrodes. Similarly, an extra layer may be added to a display substrate or an additional process such as patterning applied to an existing layer.

In some touchpad embodiments, the sensing elements 121 are disposed on a substrate of a touchpad. In such an embodiment, the sensor electrodes in each sensing element 121 and/or the substrate may be substantially opaque. In some embodiments, the substrate and/or the sensor electrodes of the sensing elements 121 may comprise a substantially transparent material.

In one configuration, as illustrated in FIG. 2A and further discussed below, the processing system 110 of the input device 295 comprises a sensor controller 218 that is coupled through connectors 217 to each of the transmitter and receiver electrodes, such as sensor electrodes 202 and 211, through one or more traces (e.g., traces 212 and 213) respectively. In one embodiment, the sensor controller 218 is generally configured to transmit the transmitter signal and receive the resulting signals from receiver electrodes. The sensor controller 218 is also generally configured to communicate the positional information received by the sensing elements 121 to the electronic system 190 and/or the display controller 233, which is also coupled to the electronic system 190. The sensor controller 218 may be coupled to the electronic system 190 using one or more traces 221 that may pass through a flexible element 251 and be coupled to the display controller 233 using one or more traces 221A that may pass through the same flexible element 251 or a different connecting element, as shown. While the processing system 110 illustrated in FIG. 2A schematically illustrates a single component (e.g., IC device) to form the sensor controller 218, the sensor controller 218 may comprise two or more controlling elements (e.g., IC devices) to control the various components in the processing system 110 of the input device 295. The controller devices may be placed onto display substrates such as TFT or Color Filter/Sealing layers (e.g. as a Chip On Glass).

In one configuration, the functions of the sensor controller 218 and the display controller 233 may be implemented in one integrated circuit that can control the display module elements and drive and/or sense data delivered to and/or received from the sensor electrodes. In various embodiments, calculation and interpretation of the measurement of the resulting signals may take place within the sensor controller 218, display controller 233, a host electronic system 190, or some combination of the above. In some configurations, the processing system 110 may comprise a transmitter circuitry, receiver circuitry, and memory that is disposed within one or any number of ICs found in the processing system 110, depending to the desired system architecture.

The input device 295 may further include a wireless communication system 150 that is configured to communicate with an external wireless communication device. In one configuration, the wireless communication system 150 is configured to use an NFC communication technique to communicate with external wireless communication devices using various electrical radio frequency (RF) enabled components found in the signal processing unit 152. The signal processing unit 152 is configured to provide wireless communication information to the electronic system 190 and receive wireless communication information from the electronic system using via a communication link. In one embodiment, the signal processing unit 152 may comprise a radio frequency source 153 that is configured to deliver a wireless communication signal (e.g., RF signal) to an external wireless communication device by use of the coil 151, and a radio frequency receiver 154 that is configured to receive a wireless communication signal from the external wireless communication device using the coil 151. As is schematically illustrated in FIG. 2A, and discussed further below, the coil 151 is positioned and aligned relative to the sensor electrodes 202, 211 and traces 212, 213 to minimize the issues created by performing wireless communication processes in close proximity to the array of sensing elements 215.

FIG. 2B is a schematic view of one sensing element 121 disposed in an array of sensing elements 215 (not shown) of the input device 100, which is part of the processing system 110 of an input device 295 according to one or more of the embodiments described herein. The processing system 110 may comprise a signal generating processor 255 and a sensor processor 256 that work together to provide capacitive sensing receiver channel output signals to the electronic system 190. As discussed above, the positional information of an input object 140 (FIG. 1) is derived based on the capacitance measured between each of the transmitter electrodes and the receiver electrodes contained in the array of sensing elements 215 in the sensing region 120.

The signal generating processor 255 and sensor processor 256 may work together to provide touch sensing data to the electronic system 190. The sensor processor 256 may be part of the processing system 110 and/or part of the electronic system 190. In various embodiments, the sensor processor 256 will comprises digital signal processing elements and/or other useful digital and analog circuit elements that are connected together to process the receiver channel output signal(s) received from at least one receiver channel that is coupled to each of the receiver (Rx) electrodes in the array of sensing elements 215. The electronic system 190 can then use the processed signals to control some aspect of the input device 295, such as send a message to the display, perform some calculation or software related task based on instructions created by one or more software programs that are being run by the electronic system and/or perform some other function.

In one embodiment, as shown in FIG. 2B, the signal generating processor 255 comprises a driver 228, which are adapted to sequentially deliver capacitive sensing signals (transmitter signals) to the transmitter (Tx) electrodes in the array of sensing elements 215. In one configuration, the driver 228 may comprise a power supply and signal generator that is configured to deliver a square, rectangular, trapezoidal, sinusoidal, Gaussian or other shaped waveforms used to form the transmitter signal(s) to the transmitter electrodes. In one configuration, the signal generator comprises an electrical device, or simple switch, that is able to deliver a transmitter signal that transitions between the output level of the power supply and a low display voltage level.

In one embodiment, as shown in FIG. 2B, the sensor processor 256 comprises a plurality of receiver channel(s) 207 that each have a first input port 241 that is configured to receive the resulting signal received by at least one receiver electrode 211, and an output port coupled to the electronic system 190. Typically, each receiver channel is coupled to a single receiver electrode 211. Each of the plurality of receiver channels 207 may include a charge accumulator, supporting components, such as demodulator circuitry, a low pass filter, sample and hold circuitry, other useful electronic components filters and analog/digital converters (ADCs) or the like. The analog/digital converter (ADC) may comprise, for example, a standard 8, 12 or 16 bit ADC that is adapted to receive an analog signal and deliver a digital signal (receiver channel output signal) to the electronic system 190 (e.g. a Successive Approximation ADC, a Sigma-Delta ADC, an Algorithmic ADC, etc). In one configuration, the charge accumulator includes an integrator type operational amplifier. In one configuration, the sensor processor 256 further comprises an EMI filter 299 that is adapted to filter any EMI induced by other input device components, such as the wireless communication system 150.

### Integrated Touch Sensing and Wireless Communication Designs

As noted above, due to the presence of shielding that is used to protect other hardware components in the processing system 110 from EMI interference, use a coil that is sized to improve communication between devices and/or the need to conserve space, it is often desirable to position the coil 151 of the wireless communication system 150 within the sensing region 120; further improving manufacturability and aesthetics. However, to communicate via a wireless technique, the coil 151 is driven and/or configured to receive a radio frequency signals. In one example, the radio frequency signals generated by the signal processing unit 152, which is used to form the communication link 165 with the wireless communication device 160, may be delivered at a radio frequency (RF) level, such as 13.56 MHz.

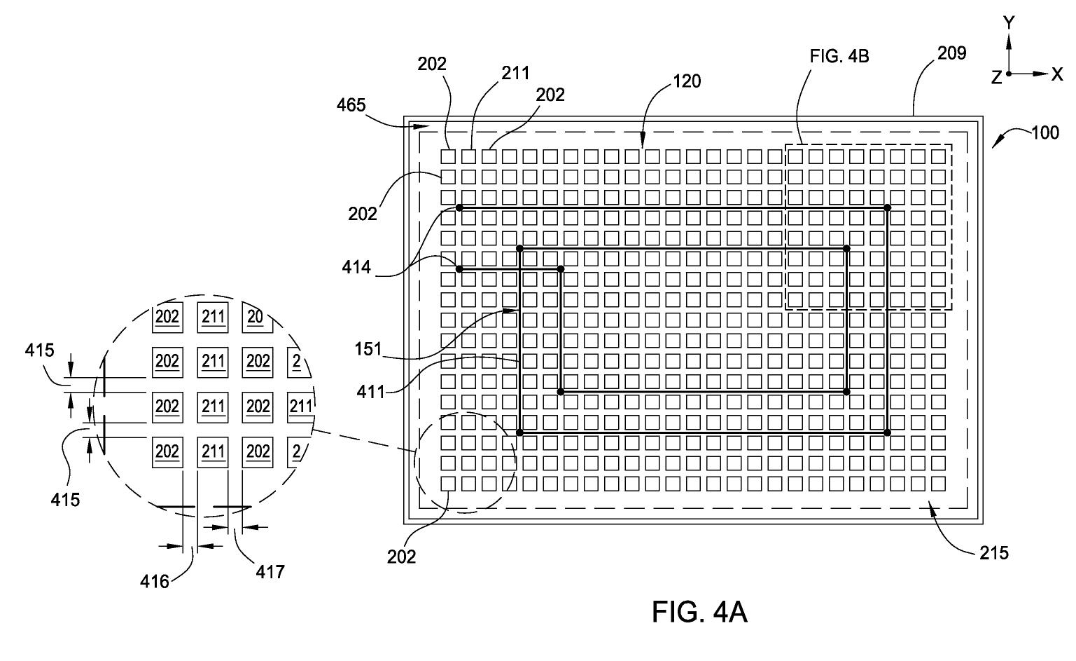

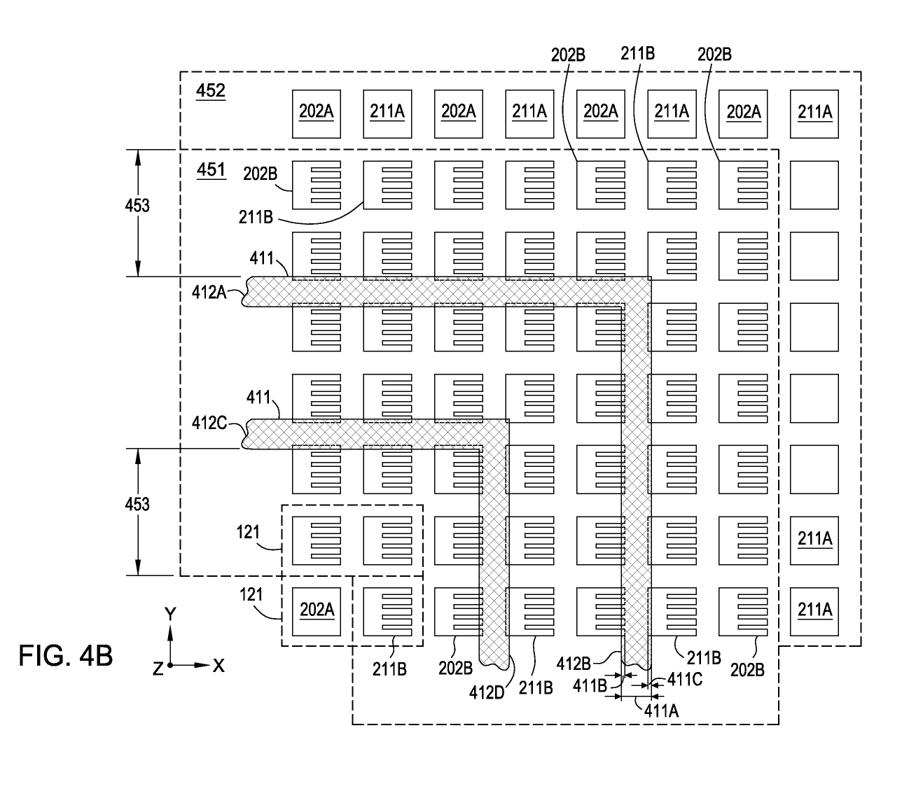

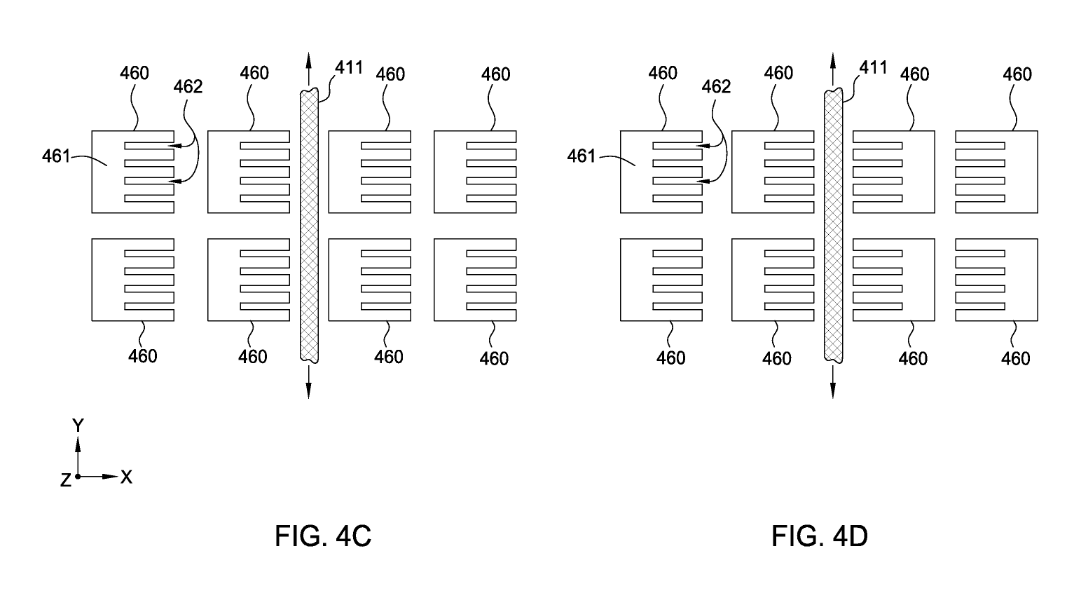

However, it has been found that if the positioning and alignment of the coil 151 to the sensing electrodes is not accounted for in the design of the input device 100, the magnetic field “M” generated during the operation of the wireless communication system 150 will undesirably interact with the components found in the sensing region 120. It is believed that these undesirable effects are caused by the interaction of the induced magnetic field “M” and the often large conductive regions found in the sensing region 120, such as the sensor electrodes. The magnetic field “M,” which is induced by the high frequency alternating current “I” delivered through the coil 151 by the signal processing unit 152, creates eddy currents “C” that are induced in the conductive objects that have a significant size. The presence of the sensing electrodes near the coil 151 can also undesirably attenuate the magnetic field induced wireless communication signal (e.g., near field communication (NFC) signal). Also, positioning the coil 151 proximate to the sensing region 120 can also increase the electrical capacitance of the coil and thus create an undesirable reduction in the self-resonance frequency of the coil which will affect the ability of the “tuned” wireless communication components to communicate with each other. However, the planar distance over which the coil 151 extends (e.g., X and Y directions in FIG. 4A) can affect the coupling between the wireless devices and its self resonant frequency. Desirable coil 151 dimensions are typically smaller than the outside dimensions of the sensing region 120 in most input devices. In one example, the outside dimension of a four turn rectangular shaped planar shaped coil 151 being 3.5 cm by about 5 cm, while the sensing region 120 dimensions of a touch pad type of input device 100 being about 6 cm by about 10 cm. In another example, the outside dimension of a rectangular shaped planar shaped coil 151 is about 1.5 cm by 1.5 cm to about 5 cm by 8 cm, while the dimensions of the sensing region 120 are at least 5 cm by 8 cm.

Therefore, there is a need for an input device design that allows for the reliable capacitive sensing of an input object 140 and reliable wireless communication between the electronic system 190 and other external wireless communication devices. Some embodiments of the invention, as discussed below, will include configurations in which the positioning and alignment of the coil 151 relative to the touch sensing components are configured so that the wireless communication techniques completed by the wireless communication system 150 will minimally affect each other's performance during normal operation.

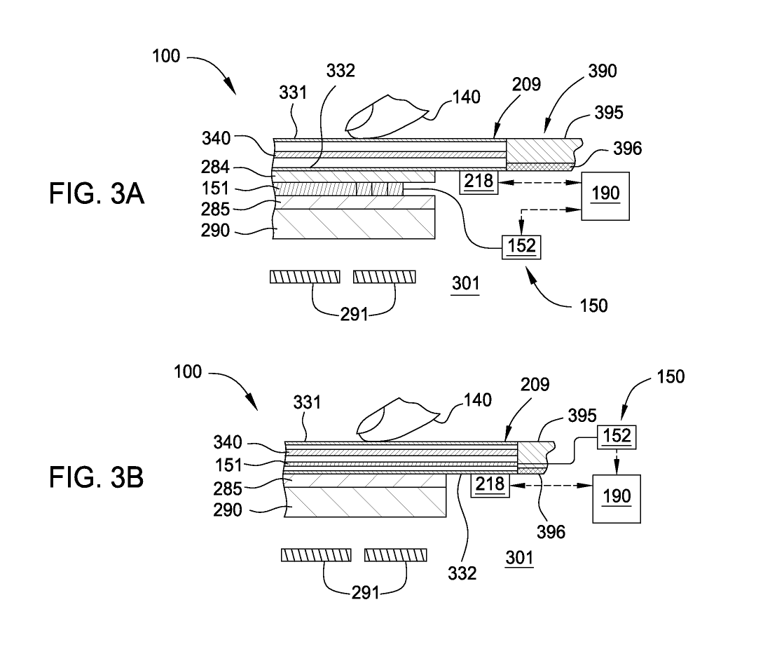

FIG. 3A is a schematic side cross-sectional view of a portion of the input device 100, according to one embodiment of the invention. In one configuration, as shown in FIG. 3A, the input device 100 includes a substrate 209 that is coupled to part of an enclosure 390, which is used to hold the various components that form the input device 100. The enclosure 390 may include a structural member 395 (e.g., plastic sheet, metal sheet), which is used to support and retain the various components used to form the input device 100, and a shielding element 396 (e.g., ground plane), which is used to shield the components in the internal region 301 of the input device 100 from EMI.

In some embodiments, the substrate 209 includes a sensor electrode containing region, hereafter sensor region 340, which contains one or more layers of sensor electrodes that form an array of sensing elements 215 (not shown) that are used to perform a touch sensing function as discussed above. While FIG. 3A illustrates the sensor region 340 as being in the middle of the substrate 209, this configuration is not intended to be limiting as to the scope of the invention, since the sensor electrodes could also be disposed on an exposed surface 331 (or upper surface as shown) and/or an internal surface 332 (or lower surface as shown) of the substrate 209. In some configurations, the sensor controller 218, which is coupled to the sensor electrodes in the sensor region 340, may be attached or coupled to the substrate 209.

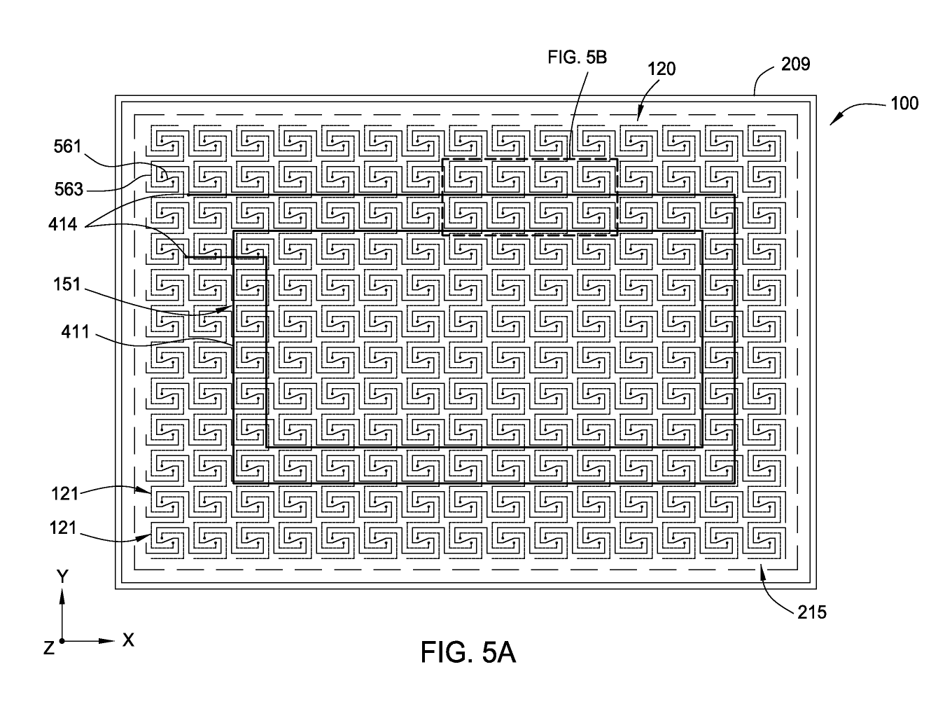

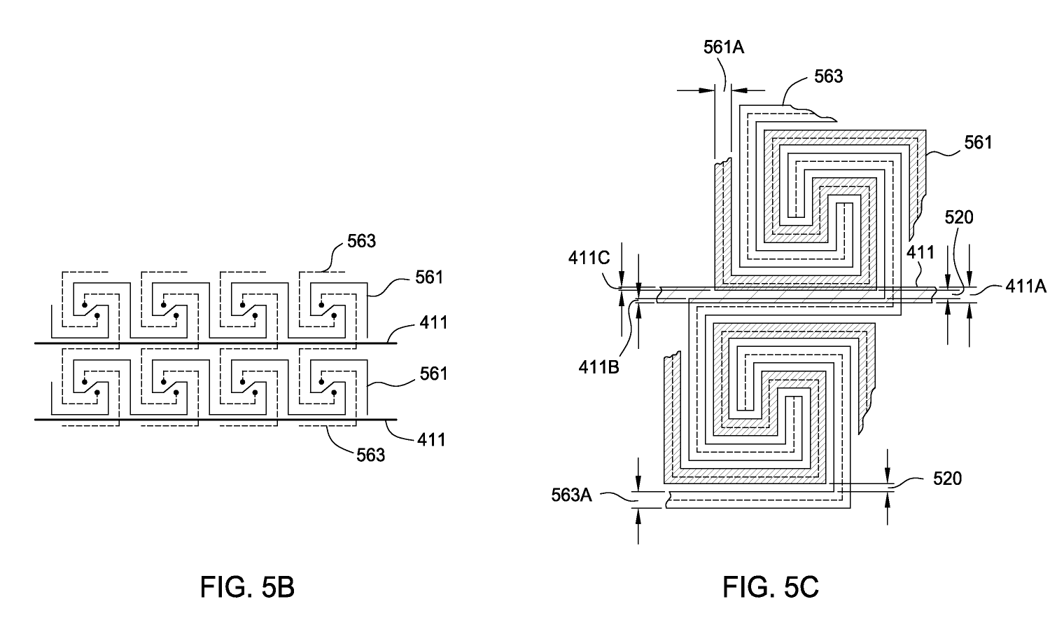

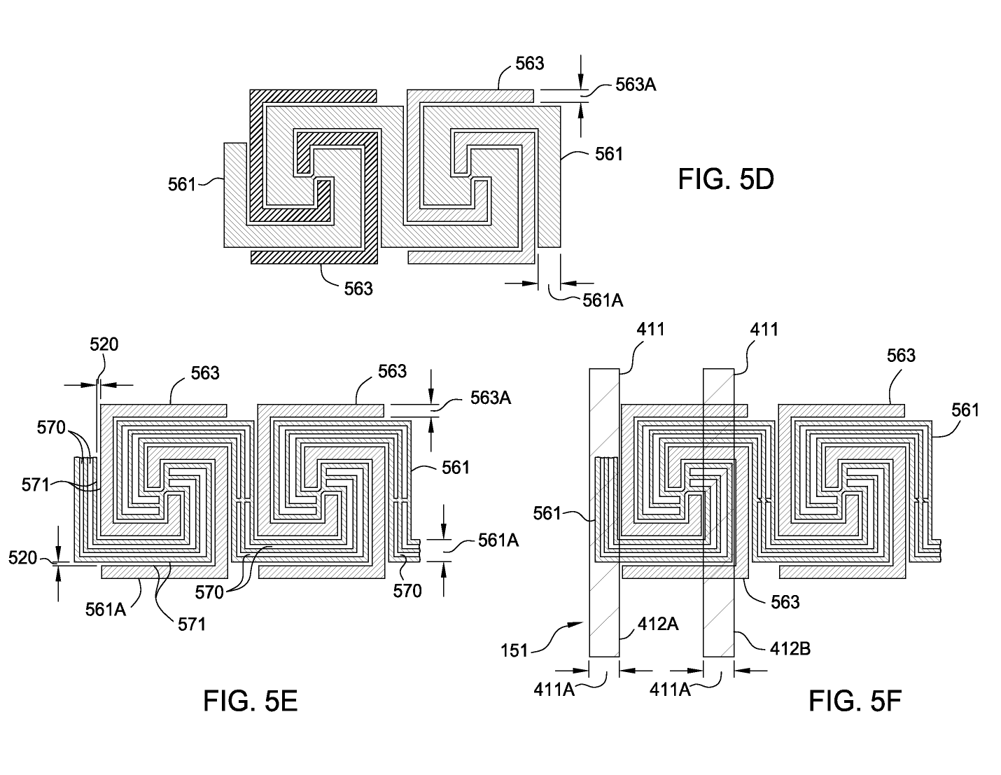

In some configurations, as shown in FIG. 3A, the coil 151 of the wireless communication system 150 is bonded to the internal surface 332 of the substrate 209 using a bonding layer 284 (e.g., adhesive material). The coil 151 is generally a conductive trace, such as a metal containing wire or other similar conductive element that is formed into single or multiple loop configuration of a desired size to effectively communicate with other external wire communication devices. In one example, the coil 151 is aligned in a planar coil configuration, so that conductive trace elements of the coil 151 generally reside within a plane (e.g., X-Y plane in FIGS. 4A and 5A). In this configuration, the conductive portions of the coil, or conductive traces, are configured to be substantially parallel to a surface of the substrate 209 or a plane that is parallel to a surface of the substrate 209. The conductive traces of the coil 151 may be formed from a metal, such as copper (Cu), silver (Ag), gold (Au), tin (Sn), iron (Fe), ferrite or other useful conductive element. In one example, the planar coil includes between about one and five turns and has an aspect ratio in a first planar direction to a second perpendicular planar direction of 1:1 to 1:2.

In one configuration, the conductive traces may include conductive pathways, tracks or traces etched from copper sheets which are laminated onto a portion of a non-conductive substrate, such as layer of a printed circuit board (PCB) or a flexible polymeric sheet (e.g., Mylar). The non-conductive substrate may then be bonded to the substrate 209 using the bonding layer 284. However, in some configurations the non-conductive substrate may be positioned adjacent to a surface of the substrate 209.

In one embodiment, to reduce electrical interference or induction heating in other internal components 291 in the internal region 301 of the input device 100 (e.g., laptop batteries, computer processing elements (e.g., CPU, memory)), the coil 151 is disposed between the substrate 209 and a ground plane 290. The ground plane 290 may comprise a metal sheet or foil that is bonded to the coil 151, and substrate 209, using a bonding layer 285 (e.g., adhesive material).

In one embodiment, in which the planar coil includes two or more turns, at least a portion of the conductive traces of the planar coil are disposed on, or within, two or more layers of a multi-layer substrate 209 or within portions of a separate non-conductive substrate, as discussed above. In one example, each turn of a multi-turn planar coil is disposed within a single plane (e.g., a two turn coil is shown in FIGS. 4A and 5A), but one or more jumpers (not shown), which extend through an adjacent layer, is used to form a part of the planar coil to prevent shorts between sections and/or loops (i.e., turns) of the planar coil. For example, the routing of the planar coil's conductive traces 411 (FIG. 4A) to the external connection points 414 (FIG. 4A) can be completed without shorting the routing portion to another portion of the conductive trace 411 by use of a jumper. In one configuration, a jumper may be used to connect the lower external connection points 414 in FIG. 4A to the centrally placed end of the planar coil, thus preventing a short between this connection and the overlapping y-direction oriented middle portion of the coil 151.

In another configuration of the planar coil design, the planar coil has conductive traces 411 (FIG. 4A) that are spread out over the X and Y directions and have a first turn of the planar coil that is disposed on one layer of the substrate and a second turn of the planar coil is on a second layer of the substrate. In this case, the first turn is connected to the second turn using interconnecting vias that pass through an insulating layer disposed between the first turn and the second turn. In this example, the planar coil can be considered to be substantially planar due to the conductive traces 411 being spread out over the X and Y directions versus the small Z direction distance over which the coil extends because of the presence of the typically thin insulating layer positioned between the first and second turns.

FIG. 3B is a schematic side cross-sectional view of a portion of the input device 100, according to one embodiment of the invention. In one configuration, as shown in FIG. 3B, the input device 100 includes a sensor region 340 and coil 151 disposed therein. While FIG. 3B illustrates the sensor region 340 and coil 151 being in the middle of the substrate 209, this configuration is not intended to be limiting as to the scope of the invention, since the sensor electrodes in the sensing region 340 and coil 151 could also be disposed on the exposed surface 331 (or upper surface as shown) and/or internal surface 332 (or lower surface) of the substrate 209. In one example, the sensing region 340 and coil 151 are both disposed on the internal surface 332 of the substrate 209. In another example, one layer of sensing electrodes are disposed on the exposed surface 331 (e.g., receiving electrodes), one layer of sensing electrodes are disposed on the internal surface 332 (e.g., transmitting electrodes), and the coil 151 is disposed on the internal surface 332. In some configurations, the ground plane 290 is bonded to the internal surface 332 of the substrate 209, using a bonding layer 285 (e.g., adhesive material).

FIG. 4A is a schematic plan view of the sensing region 120 of the input device 100, according to one embodiment of the invention. In one embodiment, the sensing region 120 includes an array of sensing elements 215 that are disposed across a surface of the substrate 209 and a coil 151. In one embodiment of the input device 100, the array of sensing elements 215 includes a plurality of sensor electrodes 202 that are connected together in rows (e.g., X-direction) and a plurality of sensor electrodes 211 that are connected together in columns (e.g., Y-direction). In one example, the plurality of sensor electrodes 202 are transmitter (Tx) electrodes and the plurality of sensor electrodes 211 are receiver (Rx) electrodes that each have traces (not shown) that are separately connected together in the border region 465 of the substrate 209. The array of sensing elements 215, as shown in the enlarged view shown in FIG. 4A, may include a first gap 415 that is disposed between each of the rows of sensor electrodes 202 and 211 (Y-direction), a second gap 416 that is disposed between each of the sensor electrodes 202 and 211 (X-direction) and a third gap 417 that is disposed between each adjacent touch sensing element, for example as shown, each adjacent pair of sensor electrodes 202 and 211 (X-direction). One skilled in the art will appreciate that that first, second and third gaps need not be equal in size to each other, and the size of each first gap, each second gap and/or each third gap may vary in different regions of the sensing region 120. In general, the gap 416 formed between the edge of a first type of sensor electrode (e.g., sensor electrode 202) and a second type of sensor electrode (e.g., sensor electrode 211) is small enough to assure ohmic isolation, but is sized to achieve a desirable capacitive coupling between the sensor electrodes.

One will note that the gaps 416 between the columns of sensor electrodes 202 and 211, as shown in the enlarged view in FIG. 4A, can be said to be aligned along the Y-direction and the gaps 415 between the rows, which contain sensor electrodes 202 and 211, can be said to be aligned along the X-direction. Also, one will note that each of the gaps 415 are formed between a pair of sensor electrodes 202 (e.g., nearest neighbors), the gaps 416 are each formed between a pair of sensor electrodes 202 and 211 (e.g., one sensor electrode 202 and its nearest neighbor sensor electrode 211) and the gaps 417 are each formed between adjacent touch sensing elements that may include a pair of sensor electrodes 202 and 211 (e.g., one sensor electrode 211 and its nearest neighbor sensor electrode 202). One skilled in the art will appreciate that the rectangular layout of sensor electrodes 202 and 211 shown in FIG. 4A is not intended to be limiting, since other non-rectangular sensor electrode layouts can be used without deviating from the basic scope of the invention described herein. In one example, each sensor electrode 202 that is not on the edge of the sensing region 120 need not have two nearest neighbors that are sensor electrodes 202 (e.g., above and below) and two nearest neighbors that are sensor electrodes 211 (e.g., left side and right side), but could have four nearest neighbors that are sensor electrodes 211 or be formed in a configuration that is mirror image of the configuration shown. Also, unit cells 222 within the array of sensing elements 215, which are discussed above, may have more or less nearest neighbors than four.

The coil 151 may include a plurality of conductive traces 411 that are coupled together to form a multi-turn coil that has two external connection points 414. The external connection points 414 may form part of a connector that is used to connect the coil 151 to the signal processing unit 152 (not shown in FIG. 4A). In one embodiment, as shown in FIG. 4A, the coil 151 is positioned such that at least a portion of the conductive traces 411 are aligned with and positioned within the gaps formed between the sensor electrodes. It has been found that by aligning and positioning the conductive traces 411 relative to the array of sensing elements 215, the amount of unwanted interference to the wireless communication process is reduced, and the EMI's affect on groups of sensor electrodes, or any one sensing electrode, during the touch sensing process is dramatically reduced.

FIG. 4B is an enlarged plan view of a portion of the sensing region 120 shown in FIG. 4A. As shown in FIG. 4B, the conductive traces 411 are disposed over the gaps formed between the sensor electrodes (e.g., sensor electrodes 202B and 211B). In one configuration, the segments 412A-412D of the conductive traces 411 have a width 411A that is wider than the gaps formed between the sensor electrodes, thus creating an overlap 411B and 411C between the conductive traces 411 and portions of the sensor electrodes. To prevent the interference in any one sensor electrode, or group of connected sensor electrodes, from being larger than another, the overlap 411B and 411C between the conductive traces 411 and the sensor elements is held constant across all portions of the array of sensing elements 215. In some cases, it is desirable to assure that the sum of the overlap 411B and overlap 411C of the conductive traces 411 are greater than zero and at least as wide as one of the senor electrodes to assure that the attenuation of the wireless communication signal is not affected by the array of sensing elements 215.

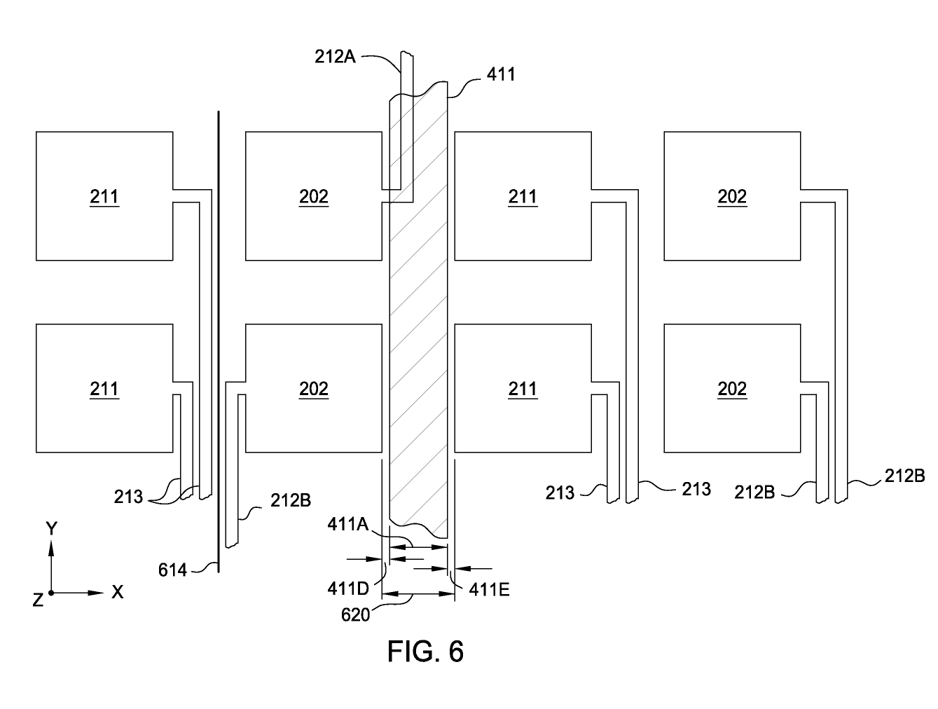

In other configurations, the segments of the conductive traces 411 have a width 411A that is smaller than the gaps formed between the sensor electrodes, thus creating a gap 411D and 411E (FIG. 6) between the segments of the conductive traces 411 and portions of the sensor electrodes. Thus, to avoid or prevent the interference in any one sensor electrode, or group of connected sensor electrodes, from being larger than another the gap 411D and 411E formed between the conductive traces 411 and the sensor elements is equal and constant across all portions of the array of sensing elements 215.

Referring back to FIG. 4B, in some embodiments of the input device 100, the sensor electrodes that are disposed in close proximity to the segments 412A-412D of the conductive traces 411 are shaped to reduce the eddy currents that will be induced in the sensor electrodes due to the magnetic field “M” generated by the coil 151 during the wireless communication processes. In one example, all of the sensor electrodes 202B and 211B that are disposed within a distance 453 from the conductive traces 411 have a desired shape that prevents or reduces eddy currents formed in these sensor electrodes. Sensor electrodes that are not in close proximity to the conductive traces 411, such as sensor electrodes 202A and 211A, can have a different and/or simplified shape, since the fields generated by the coil 151 are less likely to induce a significant eddy current in these sensor electrodes. The sensor electrodes 202B and 211B that are disposed within the distance 453 from the conductive traces 411 may be referred to as being disposed in an interference prone region 451 and the sensor electrodes 202A and 211A that are disposed a distance greater than the distance 453 from the conductive traces 411 may be referred to as being disposed in a non-interference prone region 452. However, in one example, the formed sensing element 121, which may include two or more sensor electrodes, can include parts of one or both regions 451, 452 and contain sensor electrodes that have different shapes.

FIG. 4C is an enlarged plan view of a plurality of sensor electrodes 460 that are disposed within the interference prone region 451 of the sensing region 120, due to their proximity to a segment of the conductive trace 411. Each of the sensor electrodes 460 may comprise a conductive material, such as a thin metal layer (e.g., copper, aluminum, etc.) or a thin transparent conductive oxide layer (e.g., ATO, ITO, zinc oxide) that is deposited on one or more layers on or within the formed substrate 209 using conventional deposition techniques known in the art (e.g., PVD, CVD). In one or more of the embodiments described herein, the sensor electrodes are formed from a material that is substantially optically clear, and thus, in some configurations, can be disposed between a display device and the input device user. The sensor electrodes 460 illustrated in FIG. 4C may be transmitter (Tx) electrodes and/or receiver (Rx) electrodes, such as electrodes 202, 202B and/or 211, 211B, which are discussed above.

In one configuration, as shown in FIG. 4C, the sensor electrodes 460 are shaped to reduce the eddy current that will be induced in the sensor electrodes due to the magnetic field “M” generated by the coil 151. In one configuration, this is accomplished by forming slots 462, or open regions, within the electrode body 461 of the sensor electrode 460 to reduce the effective planar area of each of the sensor electrodes 460. In other words, the footprint of the sensor electrode 460 (i.e., area defined by the outside dimensions of the sensor electrode (or foot print area)) is larger than the actual surface area of the sensor electrode 460. Reducing the continuous area of the electrode body 461, by breaking it up into smaller interconnected segments, helps mitigate the magnitude of the induced eddy current(s).

Moreover, one skilled in the art will appreciate that the capacitive coupling between adjacent sensor electrodes (e.g., electrodes 202B and 211B in FIG. 4B) is primarily created by the electric fields formed at or near the edges of the sensor electrode, due to the proximity of the opposing electrodes. Therefore, sensor electrodes 460 that have a larger edge length or electrode perimeter, due to the inclusion of the slots 462, will generally have a higher coupling between adjacent transmitter (Tx) and receiver (Rx) electrodes. Typically, large variations in the total planar surface area (X-Y plane) of a sensor electrode 460 will only have a small effect on the capacitive coupling between the electrodes. In some configurations, the sensor electrodes may be formed so that the slots 462 in adjacent sensor electrodes 460 interleave, or are interdigitated with, each other to maximize the length of the adjacent edges of the sensor electrodes to improve the capacitive coupling between the sensor electrodes in a sensing element 121.

FIG. 4D is an enlarged plan view of an alternate configuration of a plurality of sensor electrodes 460 that are disposed within an interference prone region 451 of the sensing region 120. In one configuration, one or more of the sensor electrodes 460 can be formed in differing orientations or shapes of the sensor electrodes (not shown) to alter the position or routing of the sensor electrodes and/or reduce the interference created within the electrode due to its position relative to the conductive trace 411 (e.g., mirror image of the sensor electrodes 460 in adjacent sensor electrode arrays). The differing orientation or shape of the one or more of the sensor electrodes 460 can reduce the interaction between the fields created by the coil 151 in the sensor electrodes 460.

FIG. 5A is a schematic plan view of the sensing region 120 of another embodiment of the input device 100. In one embodiment, the sensing region 120 includes an array of sensing elements 215 that are disposed in an interleaved configuration across a surface of the substrate 209 and a coil 151. In one embodiment of the input device 100, the array of sensing elements 215 includes a plurality of sensor electrodes 561 that are connected together in rows (e.g., x-direction) and a plurality of sensor electrodes 563 that are connected together in columns (e.g., y-direction). In one example, the plurality of sensor electrodes 561 are transmitter (Tx) electrodes and the plurality of sensor electrodes 563 are receiver (Rx) electrodes, which each have traces (not shown) that are separately connected together in the border region or edge of the substrate 209. In one configuration, the sensor electrodes 563 are interconnected together in regions where the sensor electrode 561 and sensor electrode 563 cross using a jumper (not shown in FIGS. 5A-5F) that extends through an adjacent layer within the substrate 209 and interconnects two adjacent sections of the same sensor electrode.

FIG. 5B is a schematic close-up view of a portion of the sensing region 120 shown in FIG. 5A. As shown in FIG. 5B, for example, the conductive traces 411 of the coil 151 are disposed over the gaps formed between the sensor electrodes (e.g., sensor electrodes 561 and 563), and generally cross over portions of the sensor electrodes 561, 563 at an angle greater than zero degrees (e.g., overlapping portion is non-parallel with the portion of the electrode when angle is greater than zero degrees) and less than or equal to 90 degrees. In one embodiment, it is desirable to align the conductive traces 411 so that they cross over portions of the sensor electrodes (e.g., sensor electrode 563 in FIG. 5B) at an angle of about 90 degrees. In some embodiments, it is desirable to configure the coil 151 so that the conductive traces 411 only overlap portions of the transmitter (Tx) electrodes, or overlaps a larger proportion of transmitter (Tx) electrodes versus receiver (Rx) electrodes to reduce any interference induced in the receiver portions of the processing system 110, due to the capacitive coupling from the coil 151. In some configurations of the input device 100, as illustrated in FIG. 2B, it is desirable to couple the Rx electrodes to a filter 299 to reduce interference from received by the electronic system 190.

FIG. 5C is an enlarged plan view of a portion of the sensing region 120 shown in FIG. 5A. In one configuration, the conductive traces 411 have a width 411A that is wider than the gaps 520 formed between the sensor electrodes, thus creating an overlap 411B and 411C between the conductive traces 411 and portions of the sensor electrodes 561, 563. The sensor electrodes 561, 563 may each have a width 561A and 563A, respectively, and may be formed from a material similar to ones discussed above. To avoid or prevent the interference in any one sensor electrode, or group of connected sensor electrodes, from being larger than another, the overlap 411B and 411C between the conductive traces 411 and the sensor elements is equal and constant across the array of sensing elements 215.

FIG. 5D is an enlarged plan view of a portion of the sensing region 120 shown in FIG. 5A in which an alternate sensor electrode 561 and 563 design is utilized. In one embodiment, the width 563A of the Rx electrodes 563 are formed so that they are smaller than the width 561A of the Tx electrodes 561 so that the interference created in the Rx electrodes 563 and sensor processor 256 portion of the processing system 110 can be reduced. It is believed that the creation of electrical interference in the Tx electrodes 561 and signal generating processor 255 portion of the processing system has less of a detrimental affect on ability to sense the position of an input object 140 than interference created in the sensor processor 256 portion of the processing system 110. In some embodiments of the input device, to reduce the affect of interference on the overall system it is desirable to increase the ratio of the total number of transmitter electrodes to the total number of receiver electrodes. In one example, the ratio of transmitter electrodes to receiver electrodes is greater than 1.

FIG. 5E is an enlarged plan view of an alternate version of the sensor electrode design illustrated in FIG. 5D. In this configuration, to reduce the amount of electrical interference created in the signal generating processor 255 portion of the processing system 110 due to an increase in the width 561A of the Tx electrode 561, relative to the width 563A of the Rx electrode 563, it is desirable to remove portions of, or form slots 570 within, the Tx electrodes 561 to reduce the eddy currents induced in the Tx electrodes 561 during the operation of the coil 151. In one example, as shown in FIG. 5E, a plurality of slots 570 are formed within an internal region of the Tx electrodes 561 (e.g., electrode body) to maintain the linear adjacent edges 571, at the gap 520 between the Tx electrodes 561 and Rx electrodes 563, to assure that the capacitive coupling between the Tx and Rx electrodes remains relatively unchanged by the addition of the slots 570.

FIG. 5F is an enlarged plan view of a portion of the sensing region 120 shown in FIG. 5E in which the conductive traces 411 are aligned so that they primarily overlap the Tx electrodes 561 and cross the Rx electrodes 563 at right angles. This configuration will generally have a small amount of electrical interference created in the Rx electrodes 563 and sensor processor 256 portion of the processing system 110, while only inducing a small amount of interference in the Tx electrodes, due to the reduced planar surface area of the Tx electrodes 561, due to the presence of the formed slots 570. This configuration may be desirable in cases where the size of the gap 520 formed between the sensor electrodes is not large enough to accommodate the required width 411A of the conductive traces 411, and/or significant overlap between the conductive traces 411 and sensor electrodes is required.

FIG. 6 is an enlarged plan view of a portion of the sensing region 120 in which the sensor electrodes 202 and 211 are desirably arranged relative to a conductive trace 411. As shown in FIG. 6, a conductive trace 411 is disposed over the gap 620 formed between the sensor electrodes (e.g., sensor electrodes 202 and 211). In one configuration, the conductive traces 411 has a width 411A that is smaller than the gap 620 formed between the sensor electrodes, thus creating a gap 411D and 411E between the conductive trace 411 and portions of the sensor electrodes. In one configuration, as shown in FIG. 6, each of the sensor electrodes 202 include a trace 212A or 212B and each of the sensor electrodes 211 include a trace 213, which are used to provide a connection between the sensor electrodes 202, 211 and the sensor controller 218. To avoid or prevent the electrical interference in any one sensor electrode, group of connected sensor electrodes and/or sensor processor 256, it is often desirable to avoid disposing the conductive traces 411 over the sensor electrode or its trace as shown in relation to trace 212A.

In some embodiments, it is desirable to align the traces 212B and 213 so that they are a distance away from and don't overlap with a conductive trace 411. In some configurations, as illustrated on the left side of FIG. 6, a ground line 614 is disposed between traces of opposite types to prevent interaction between the Tx and Rx signals and also reduce the affect of interference induced by the coil 151 in the sensor electrodes 202 and 211. For example, the presence of the ground line 614, which may be at a ground or other desirable potential can help damp the effects of the coupling between the coil 151 and traces 212B and 213 as well as sensor electrode 202 and 211 fields generated by the coil 151.

Alternately, in some configurations, the traces 212B and 213 are positioned a distance apart from each other and also a distance from the conductive trace 411, as shown on the right side of FIG. 6. By orienting and aligning the traces 212B, 213 relative to each other and relative to the conductive trace 411 the interference induced by the coil 151 and cross-talk between the Tx and Rx electrodes can be reduced. In some embodiments, one or more of the sensor trace configurations described herein may also be used with one of the reduced area electrode designs (e.g., electrodes 460, 561) to minimize the affect of the interference induced by the coil 151. In some embodiments, one or more of the sensor trace configurations described herein may also include one or more slots (e.g., slot 462 and/or slot 570) in the traces 212A, 212B and 213 to reduce the affect of the interference induced by the coil 151 in the signal generating processor 255 and/or the sensor processor 256 circuitry.

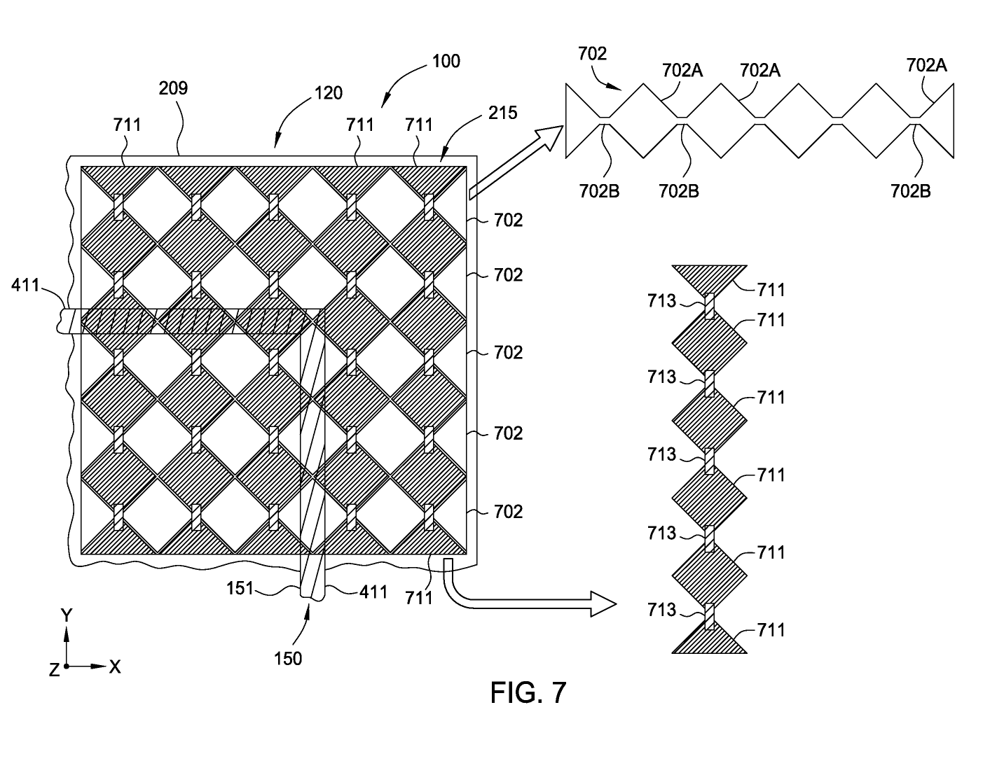

FIG. 7 is a schematic plan view of a portion of the sensing region 120 of the input device 100, according to one embodiment of the invention. In one embodiment, the sensing region 120 includes an array of sensing elements 215 that are disposed in an interleaved configuration across a surface of the substrate 209 and a coil 151. In one embodiment of the input device 100, the array of sensing elements 215 includes a plurality of sensor electrodes 702 that are connected together in rows (e.g., X-direction) and a plurality of sensor electrodes 711 that are connected together in columns (e.g., Y-direction). In one example, the plurality of sensor electrodes 702 are transmitter (Tx) electrodes and the plurality of sensor electrodes 711 are receiver (Rx) electrodes that are separately connected together in the border region or edge of the substrate 209. The sensor electrodes 702 may include a plurality of sub-electrodes 702A that include a plurality of connecting elements 702B that connect the sub-electrodes 702A together to form the sensor electrodes 702. The sensor electrodes 711 may include a plurality of jumpers 713, which extend through an adjacent layer within the substrate 209, that are used to interconnect the sensor electrodes 711 together.

In some embodiments, the conductive traces 411 of the coil 151 are aligned relative to the array of sensing elements 215 so that the conductive traces 411 cross-over connected groups of sensor electrodes at an angle that is perpendicular to the direction that the groups of electrodes are connected. In one configuration, as shown in FIG. 7, the conductive traces 411 are oriented and aligned so that the horizontally oriented conductive traces 411 (e.g., X-direction) crossover the sensor electrodes 711 that are connected in a column configuration and the vertically oriented conductive traces 411 (e.g., Y-direction) crossover the sensor electrodes 702 that are connected in a row configuration. While the conductive traces 411 may cross-over a large region of some of the sensor electrodes, such as sensor electrodes 711 that are in the third position from the top and sub-sensor electrodes 702A that are in the third position from the right, it is believed that the overall electrical interferences created by the coil 151 in the array of sensing elements 215 will be less than if the conductive traces 411 were aligned over a complete row of sensor electrodes 702 and/or a complete column of sensing electrodes 711.

While the sensor electrodes and sensor electrode elements disclosed herein may be illustrated as having specific shapes and sizes, these specific illustrations are not intended to be limiting. In various embodiments, the sensor electrodes and sensor electrode elements may have any other shape that is able to provide the necessary capacitive coupling and response. For example, some differing sensor electrode shapes that may be used singly or in pairs of opposing types of sensor electrodes are shown in FIGS. 2A, 4A-4D, 5A-5F, 6 and 7, and thus one skilled in the art will appreciate that any electrode shape illustrated herein could be used in conjunction with any other electrode shape disclosed herein without deviating from the basic scope of the invention. Further, the sensor electrodes and sensor electrode elements may have differing shapes within the same sensor electrode array. In yet other embodiments, the sensor electrodes and sensor electrodes elements may be any size, such that they provide the necessary capacitive coupling and response. Further, the size of the sensor electrodes and sensor electrode elements may be varied within a sensor electrode array. In yet other embodiments, the shape and size may be varied.

One will note that the input device containing a sensor electrode set may be operated such that a one or more of the transmitter electrodes in the sensor electrode set may transmit at one time, while the receiver type sensor electrodes, may be operated singly or multiply to acquire resulting signals created from the transmitter signal to determine measurements of the capacitive couplings at the capacitive pixels, which are used to determine whether an input object is present and its positional information, as discussed above.

The embodiments and examples set forth herein were presented in order to best explain the present technology and its particular application and to thereby enable those skilled in the art to make and use the present technology. Those skilled in the art will recognize that the foregoing description and examples have been presented for the purposes of illustration and example only. The description as set forth is not intended to be exhaustive or to limit the present technology to the precise form disclosed. While the foregoing is directed to embodiments of the present invention, other and further embodiments of the invention may be devised without departing from the basic scope thereof, and the scope thereof is determined by the claims that follow.

1. An input device, comprising:
an array of capacitive sensing electrodes comprising a plurality of pairs of sensor electrodes that are separated by a first gap, wherein the first gaps between two or more pairs of sensor electrodes are aligned along a first direction; and
a coil having a planar loop that is disposed within a first plane, wherein the first plane is parallel to the first direction and a second direction, and the planar loop comprises:
a first conductive trace having a first length that is positioned over the first gaps formed between the two or more pairs of sensor electrodes.

2. The input device of claim 1, wherein:
the array of capacitive sensing electrodes further comprises a plurality of second gaps that are disposed between adjacently positioned pairs of sensor electrodes, and the second gaps are all aligned along the second direction, and
the planar loop further comprises a second conductive trace having a first length that is positioned over the formed second gaps.

3. The input device of claim 1, wherein the pair of sensor electrodes comprise a first sensor electrode and a second sensor electrode, and the first sensor electrode or the second sensor electrode comprises an electrode body having a plurality of slots formed therein.

4. The input device of claim 3, wherein the planar loop further comprises two or more turns, and
the array of capacitive sensing electrodes further comprises a plurality of third sensor electrodes that are all positioned a distance within the first plane greater than a first distance from a nearest portion of the planar coil, and each third electrode comprises an electrode body that does not contain a slot.

5. The input device of claim 1, wherein
the array of capacitive sensing electrodes are disposed within a sensing region,
the pairs of sensor electrodes each comprise a first sensor electrode and a second sensor electrode, wherein each first sensor electrode has a sensor trace that extends from the first sensor electrode to a border region that is formed outside of the sensing region, and
the first conductive trace crosses over a portion of each of the sensor traces, and the portion of each of the sensor traces is aligned at an angle of greater than zero degrees and less than or equal to 90 degrees to the first direction.

6. The input device of claim 5, wherein the angle is equal to 90 degrees.

7. The input device of claim 1, wherein the array of capacitive sensing electrodes is disposed on a first surface of a substrate, and the first surface is parallel to the first plane.

8. The input device of claim 1, wherein the pairs of sensor electrodes each comprise a first sensor electrode and a second sensor electrode, and the input device further comprises:
a driver configured to deliver a capacitive sensing signal to each of the first sensor electrodes; and
a plurality of receiver channels that are each configured to receive a resulting signal from at least one second sensor electrode, wherein each receiver channel comprises a filter that is configured reduce the affect of electromagnetic interference created by the coil in the receiver channel.

9. The input device of claim 1, wherein the array of capacitive sensing electrodes is disposed on a substrate, and the substrate is coupled to a display.

10. An input device, comprising:
an array of capacitive sensing electrodes comprising a plurality of sensor electrodes that are arranged in columns and rows relative to a first plane, wherein a first gap is formed between each adjacently positioned sensor electrode in the columns and a second gap is formed between each adjacently positioned sensor electrode in the rows; and
a coil having at least one planar loop that is disposed in a second plane, wherein the second plane is parallel to the first plane, and the at least one planar loop comprises a conductive trace comprising:
a first length that is positioned over a plurality of the first gaps; and
a second length that is positioned over a plurality of the second gaps.

11. The input device of claim 10, wherein the plurality of sensor electrodes comprise an electrode body having a plurality of slots formed therein.

12. The input device of claim 11, wherein the planar loop further comprises two or more turns, and
the array of capacitive sensing electrodes further comprises a second plurality of sensor electrodes that are all positioned a distance within the first plane greater than a first distance from the first length or the second length, and each of the sensor electrodes in the second plurality of sensor electrodes comprises an electrode body that does not contain a slot.

13. The input device of claim 10, wherein
the array of capacitive sensing electrodes are disposed within a sensing region,
each of the sensor electrodes comprise an electrode body and a sensor trace, wherein the sensor trace extends from the electrode body to a border region that is formed outside of the sensing region, and
the first length is aligned along a first direction and crosses over a portion of each of the sensor traces, and the portion of each of the sensor traces is aligned at an angle of greater than zero degrees and less than or equal to 90 degrees to the first direction.

14. The input device of claim 13, wherein the angle is equal to 90 degrees.

15. The input device of claim 10, wherein the plurality of sensor electrodes comprise a plurality of first sensor electrode and a plurality of second sensor electrode, and the input device further comprises:
a driver configured to deliver a capacitive sensing signal to each of the first sensor electrodes; and
a plurality of receiver channels that are each configured to receive a resulting signal from at least one second sensor electrode, wherein each receiver channel comprises a filter that is configured reduce the affect of electromagnetic interference created by the coil in the receiver channel.

16. The input device of claim 10, wherein the array of capacitive sensing electrodes is disposed on a substrate, and the substrate is coupled to a display.

17. An input device, comprising:
an array of capacitive sensing electrodes comprising a plurality of first sensor electrodes and a plurality of second sensor electrodes, wherein each first sensor electrode comprises a body region that has one or more slots formed therein, and are aligned along a first direction; and
a coil having at least one planar loop that is disposed in a first plane, wherein the first plane is parallel to the first direction and a second direction, and the at least one planar loop comprises a conductive trace that is positioned over each of the first sensor electrodes that are aligned along the first direction.

18. The input device of claim 17, wherein
the array of capacitive sensing electrodes are disposed within a sensing region,
each of the second sensor electrodes comprise an electrode body and a sensor trace, wherein the sensor trace extends from the electrode body to a border region that is formed outside of the sensing region, and
the conductive trace is aligned along a first direction and crosses over a portion of each of the sensor traces, and the portion of each of the sensor traces is aligned at an angle of greater than zero degrees and less than or equal to 90 degrees to the first direction.

19. The input device of claim 17, wherein the array of capacitive sensing electrodes is disposed on a substrate, and the substrate is coupled to a display.

20. A method of forming an input device, comprising:
receiving a substrate comprising an array of capacitive sensing electrodes that are disposed on a first surface of the substrate, wherein the array of capacitive sensing electrodes comprise a plurality of pairs of sensor electrodes that are separated by a first gap, wherein the first gaps between two or more pairs of sensor electrodes are aligned along a first direction; and
bonding a coil having a planar loop to the first surface of the substrate, wherein the bonded planar loop is disposed parallel to the first surface, and bonding the coil further comprises aligning a conductive trace of the planar loop over the first gaps.
